(19) United States
(12) Patent Application Publication
(10) Pub. No.: US 2016/0119685 A1
(43) Pub. Date: Apr. 28, 2016

(54) DISPLAY METHOD AND DISPLAY DEVICE

(71) Applicant: SAMSUNG ELECTRONICS CO., LTD., Suwon-si (KR)

(72) Inventor: Arihant JAIN, Noida (IN)

(73) Assignee: SAMSUNG ELECTRONICS CO., LTD., Suwon-si (KR)

(21) Appl. No.: 14/919,279

(22) Filed: Oct. 21, 2015

(30) Foreign Application Priority Data
Oct. 21, 2014 (IN) 5254/CHE/2014
Sep. 18, 2015 (KR) 10-2015-0132611

(51) Int. Cl. H04N 21/482; H04N 21/485; H04N 21/4782; H04N 21/8405; H04N 21/431; H04N 21/81

(52) U.S. Cl. CPC H04N 21/4826; H04N 21/4316; H04N 21/8166; H04N 21/4782; H04N 21/8405; H04N 21/4858

(57) ABSTRACT

A display method and a display device are provided. The display method includes: displaying first content in a first view mode on a screen of the display device; detecting a change from the first view mode to a second view mode by a detector; and providing, by the controller, recommended content in the second view mode based on a result of analyzing the first content in response to the change to the second view mode being detected.

### CROSS-REFERENCE TO RELATED APPLICATION

This application claims priority from Indian Patent Application No. 5254/CHE/2014, filed on Oct. 21, 2014 in the Indian Patent Office, and Korean Patent Application No. 10-2015-0132611, filed on Sep. 18, 2015 in the Korean Intellectual Property Office, the disclosures of which are incorporated herein in their entireties by reference.

### BACKGROUND

1. Field

Apparatuses and methods consistent with exemplary embodiments relate to generating and displaying recommended content.

2. Description of the Related Art

A display device is a device having a function of displaying an image viewable by a user. The user may view a broadcast via the display device. The display device displays a broadcast selected by the user on a screen among broadcasting signals transmitted from a broadcasting station. Currently, broadcasting is gradually switched from analog broadcasting to digital broadcasting all over the world.

Digital broadcasting denotes broadcasting that transmits a digital image and a voice signal. Compared with analog broadcasting, the digital broadcasting is strong against an external noise and thus has a small data loss, and is advantageous in error correction, has high resolution, and provides a clear screen. Also, unlike the analog broadcasting, the digital broadcasting may provide a dual direction service.

Also, recently, a smart television (TV) providing various content in addition to a digital broadcasting function is provided. The smart TV has an object of analyzing and providing what is wanted by a user even without a user's manipulation instead of passively operating according to a user's selection.

### SUMMARY

One or more exemplary embodiments provide a display device and a display method that may provide recommended content when detecting change of a view mode.

According to an aspect of an exemplary embodiment, there is provided a method of displaying content, the method including: displaying first content in a first view mode on a screen of the display device; detecting a change from the first view mode to a second view mode; and providing recommended content in the second view mode based on a result of analyzing the first content in response to the change to the second view mode being detected.

The providing the recommended content may include: generating a keyword corresponding to the first content; and updating the keyword in a database.

The providing the recommended content may include: mapping the first content to the second content based on information stored in the database; and determining the recommended content based on a result of mapping the first content to the second content.

The mapping the first content to the second content may include mapping the first content to the second content based on similarity between the first content and the second content.

The providing the recommended content may include changing an attribute of the second view mode in which the recommended content is displayed.

The providing the recommended content may include automatically launching the recommended content and displaying the first content and the recommended content together on the screen.

The providing the recommended content may include changing a sorting sequence of the recommended content according to a user setting.

The providing the recommended content may include: determining whether a type of the first content corresponds to one of a broadcast content type, an application program type, and a webpage type; generating a keyword corresponding to the first content based on an electronic program guide of the first content in response to the type of the first content corresponding to the broadcast content type; generating the keyword from a property or an attribute of the first content in response to the type of the first content corresponding to the application program type; and generating the keyword from a meta element of the first content in response to the type of the first content corresponding to the application program type.

The providing the recommended content may include displaying the recommended content in a format of one of a list format, a grid format, a pop-up format, a notification format, and a custom format.

Each of the first view mode and the second view mode may include one of a single view mode, a multi view mode, a single user mode, and a multi user mode.

According to an aspect of another exemplary embodiment, there is provided a display device including: a display configured to display first content in a first view mode; a detector configured to detect a change of a view mode; and a controller configured to analyze the first content and provide recommended content in a second view mode based on a result of analyzing the first content.

The controller may be further configured to generate a keyword corresponding to the first content, and update the keyword in a database.

The controller may be further configured to map the first content to the second content based on information stored in the database, and determine the recommended content based on a result of the mapping.

The controller may be further configured to map the first content to the second content based on similarity between the first content and the second content.

The controller may be further configured to change an attribute of the second view mode in which the recommended content is displayed according to a user input.

The controller may be further configured to automatically launch the recommended content.

The controller may be further configured to change a sorting sequence of the recommended content according to a user setting.

The controller may be further configured to determine whether a type of the first content corresponds to one of a broadcast content type, an application program type, and a webpage type; generate a keyword corresponding to the first content based on an electronic program guide of the first content in response to the type of the first content corresponding to the broadcast content type; generate the keyword from a property or an attribute of the first content in response to the type of the first content corresponding to the application program type; and generate the keyword from a meta element of the first content in response to the type of the first content corresponding to the application program type.

Each of the first view mode and the second view mode may include one of a single view mode, a multi view mode, a single user mode, and a multi user mode.

According to an aspect of another exemplary embodiment, there is provided a non-transitory computer readable storage medium storing a program that is executable by a computer to perform the method of displaying the content by the display device.

### BRIEF DESCRIPTION OF THE DRAWINGS

The above and/or other aspects will be more apparent by describing certain exemplary embodiments, with reference to the accompanying drawings, in which:

FIG. 1 is a diagram illustrating an environment in which a display device may be implemented according to an exemplary embodiment;

FIG. 2A is a diagram illustrating an example in which a display device displays content in a multi view mode according to an exemplary embodiment;

FIG. 2B is a diagram illustrating an example in which a display device displays content in a multi user mode according to another exemplary embodiment;

FIG. 3 is a flowchart illustrating a display method according to an exemplary embodiment;

FIGS. 4A and 4B are diagrams illustrating an example in which a display device provides recommended content according to an exemplary embodiment;

FIG. 5 is a flowchart illustrating a display method according to an exemplary embodiment;

FIGS. 6A to 6C are flowcharts illustrating a method of providing recommended content according to an exemplary embodiment;

FIGS. 7A and 7B are diagrams illustrating an example in which a display device sets a recommended content-providing function according to an exemplary embodiment;

FIGS. 8A to 8C are diagrams illustrating a format in which a display device displays recommended content according to an exemplary embodiment;

FIGS. 9 to 11 are block diagrams illustrating a construction of a display device according to an exemplary embodiment; and

FIGS. 12A to 12C are block diagrams illustrating a process in which a display device provides recommended content according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Throughout the specification, when a portion “includes” an element, another element may be further included, rather than excluding the existence of the other element, unless otherwise described.

Also, terms such as “portion”, “module” used in the specification denote a unit that processes at least one function or operation, and may be implemented in hardware or software or a combination of hardware and software.

Throughout the specification, the term “first view mode” may denote a mode of displaying at least one content selected by a user.

The term “second view mode” may denote a mode of displaying recommended content corresponding to content displayed in the first view mode. Also, each of the first view mode and the second view mode may be one of a single view mode, a multi view mode, a single user mode, and a multi user mode.

The term “single view mode” may denote a mode of displaying one content on an entire screen of a display device.

The term “multi view mode” may denote a mode of dividing a screen of a display device into a plurality of regions, and providing different content on each of the plurality of divided regions. The multi view mode may include a dual view mode of dividing a screen of a display device into two regions, and a triple view mode of dividing a screen of a display device into three regions, but is not limited thereto.

The term “single user mode” may denote a mode in which a display device displays one content regardless of a direction in which a user views a screen of the display device.

The term “multi user mode” may denote a mode in which a display device may display different content depending on a direction in which a user views a screen of the display device.

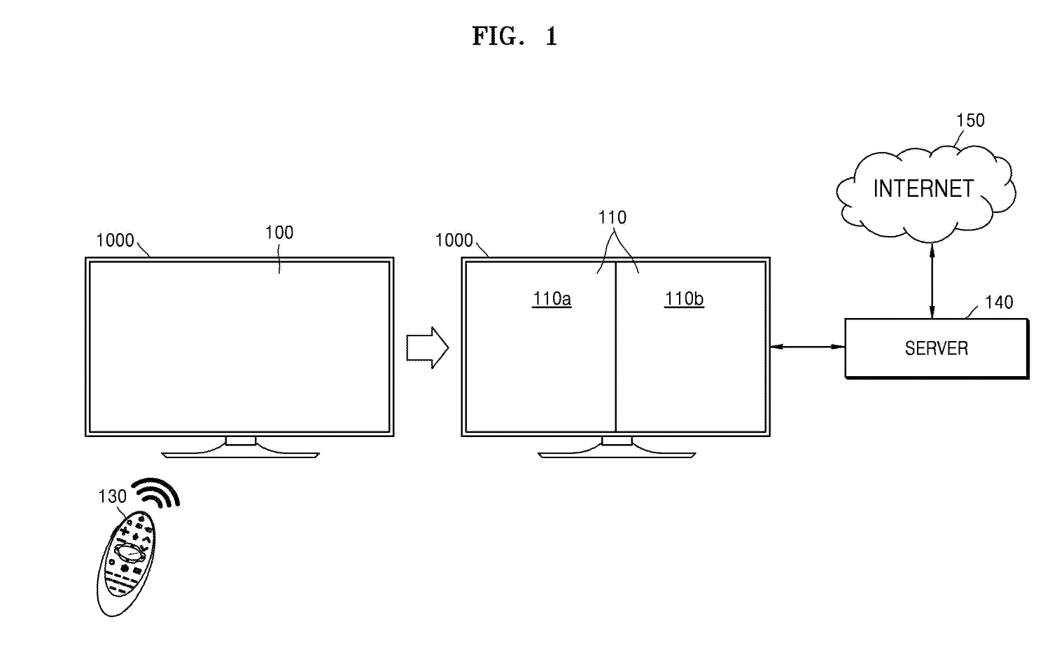

FIG. 1 is a diagram illustrating an environment in which a display device 1000 may be implemented according to an exemplary embodiment.

As illustrated in FIG. 1, the display device 1000 may be a television (TV). However, this is an exemplary embodiment and the display device 1000 may be implemented as an electronic device including a display. For example, the display device 1000 may be implemented as various electronic devices such as a mobile phone, a tablet personal computer (PC), a digital camera, a camcorder, a laptop computer, a desktop computer, an electronic book terminal, a terminal for digital broadcasting, a personal digital assistant (PDA), a portable multimedia player (PMP), a navigation device, an MP3 player, a wearable device, etc., but is not limited thereto.

Also, the display device 1000 may be a fixed type device or a mobile type device, and may be a digital broadcasting receiver that may receive digital broadcasting.

The display device 1000 may display first content in a first view mode 100.

The first view mode 100 may be one of a single view mode, a multi view mode, a single user mode, and a multi user mode depending on a user's input. For convenience in description, the case where the first view mode 100 is a single view mode is exemplarily described below.

The first content may be one of an application, web content, and broadcast content selected by a user, but is not limited thereto.

Referring to FIG. 1, the display device 1000 may detect a user input that changes the first view mode 100 to a second view mode 110. For example, the display device 1000 may detect a change from the first view mode 100 to the second view mode 110 based on a signal received from a user input device 130.

The user input device 130 according to an exemplary embodiment may be one of a remote controller, a touch pad, a gesture voice, a touch ball, an attentive user interface (AUI), a text-based interface, and an electronic mouse, but is not limited thereto.

When detecting the change to the second view mode 110, the display device 1000 may provide recommended content corresponding to the first content in the second view mode 110. The second view mode 110 may be one of a single view mode, a multi view mode, a single user mode, and a multi user mode, but is not limited thereto. Also, as described above, the multi view mode may include the dual view mode and the triple view mode, but is not limited thereto. Hereinafter, for convenience in description, the case where the second view mode 110 is the dual view mode is exemplarily described.

Referring to FIG. 1, in the case of the dual view mode, the display device 1000 may divide a screen into two regions. In this case, the display device 1000 may display first content in a first region 110a among the two regions, and display the recommended content corresponding to the first content in a second region 110b. According to an exemplary embodiment, the dual view mode may include not only dividing the screen in a vertical direction as illustrated in FIG. 1 but also dividing the screen in a horizontal direction.

The recommended content may be at least one of broadcast content, web content, and an application stored in the display device 1000, a cloud/server 140, and an external storage device, but is not limited thereto.

According to an exemplary embodiment, the display device 1000 may provide recommended content having a type different from the type of the first content. For example, in the case where the first content is broadcast content, the recommended content may be an application or web content, but is not limited thereto.

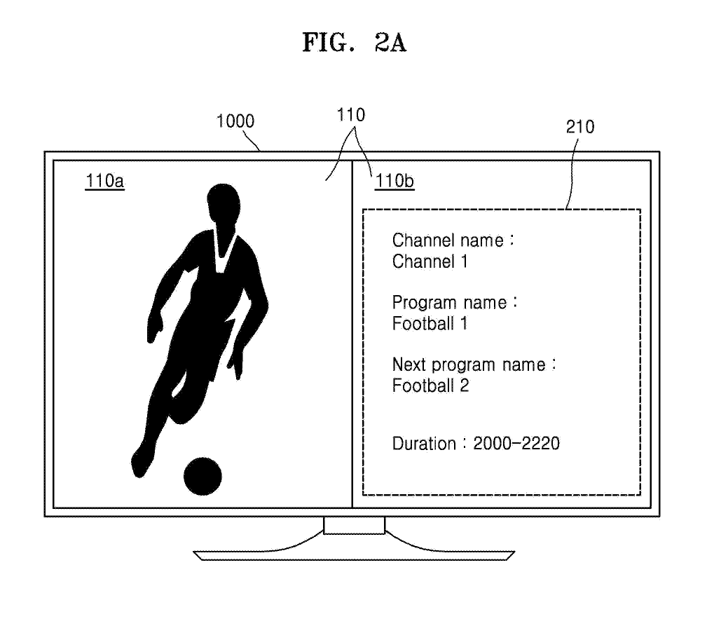

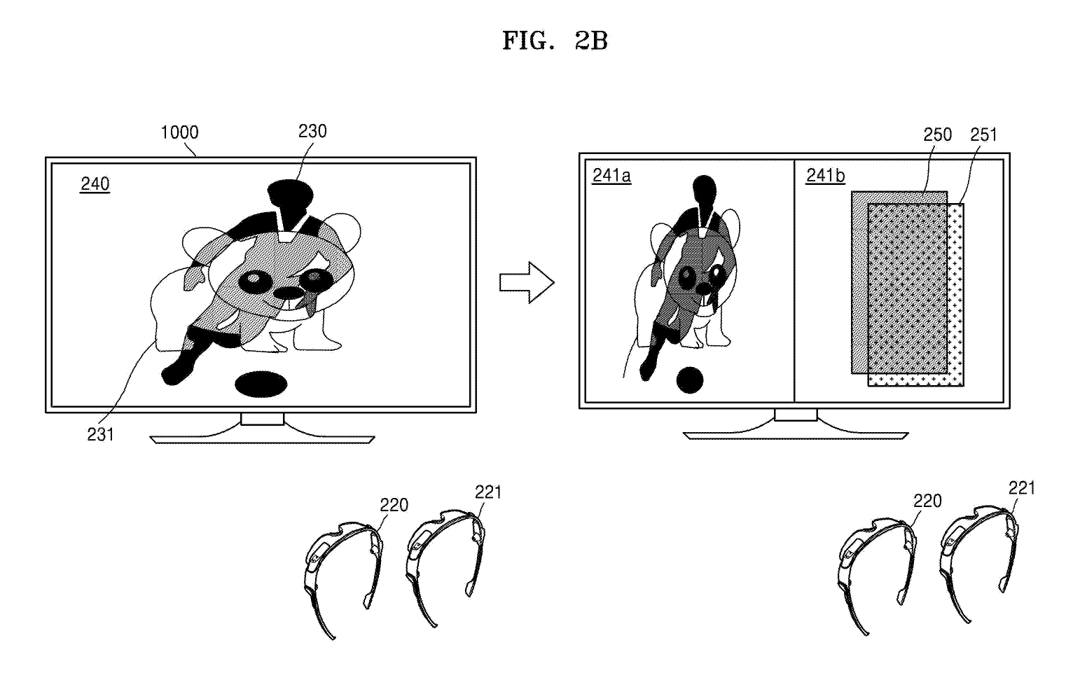

FIG. 2A is a diagram for explaining the multi view mode 110 of the display device 1000 according to an exemplary embodiment.

In the multi view mode 110, the display device 1000 may divide the screen into a plurality of regions and display content.

Referring to FIG. 2A, the display device 1000 may display content in the dual view mode 110 that divides the screen into the two regions 110a and 110b.

According to an exemplary embodiment, the display device 1000 may display independent content in the two regions 110a and 110b, or display related content in the two regions 110a and 110b. For example, as illustrated in FIG. 2A, the display device 1000 may display broadcast content in the first region 110a among the two regions 110a and 110b, and display, in the second region 110b, information 210 related to the broadcast content displayed in the first region 110a. The information 210 displayed in the second region 110b may include a channel name, a program name, a next program name, broadcasting duration, etc. of the broadcast content displayed in the first region 110a, but is not limited thereto.

FIG. 2B is a diagram for explaining a multi user mode of a display device 1000 according to an exemplary embodiment.

In the multi user mode, a first user may view one content 230 on a screen 240 of the display device 1000 by using multi user glasses 220. Simultaneously, a second user may view different content 231 on the screen 240 of the same display device 1000 by using different multi user glasses 221. Here, the multi user glasses 220 and 221 may be devices used when the first user and the second user view only desired content 230 and 231, respectively, in the one display device 1000. Accordingly, the first user and the second user may view the content 230 and 231, respectively, without interfering with each other.

For example, referring to FIG. 2B, the first user may view the content 230 related to a soccer by using the multi user glasses 220. Simultaneously, the second user may view the content 231 related to a cartoon on the screen 240 of the same display device 1000 by using the multi user glasses 221.

When detecting a user input that changes a view mode, the display device 1000 may divide the screen 240 into two regions 241a and 241b. Also, the display device 1000 may display the content 230 and 231 viewed by the first user and the second user in the first region 241a among the two regions 241a and 241b, and display, in the second region 241b, information 250 and 251 related to the content 230 and 231 displayed in the first region 241a. Accordingly, the information 250 and 251 displayed in the second region 241b may overlap each other.

However, the first user may view the content 230 related to a soccer and the information 250 related to the content 230 by using the multi user glasses 220. Also, the second user may view the content 231 related to a cartoon and the information 251 related to the content 231 by using the multi user glasses 221.

Also, according to an exemplary embodiment, the display device 1000 may divide the screen into two or more regions, and is not limited to the above exemplary embodiment.

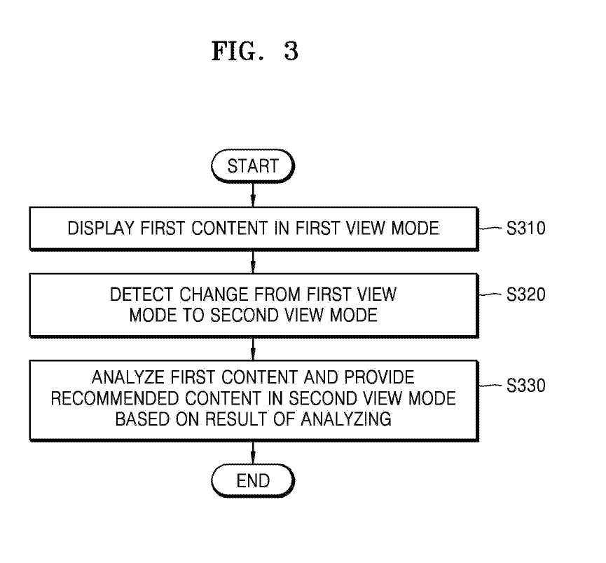

FIG. 3 is a flowchart illustrating a display method according to an exemplary embodiment.

In operation S310, the display device 1000 may display first content in a first view mode. The first content may be one of broadcast content, web content, and an application stored in the display device 1000, a cloud, an application server, and an external storage device, but is not limited thereto.

In operation S320, the display device 1000 may detect a change from the first view mode to a second view mode. For example, the display device 1000 may detect a change from the first view mode to the second view mode based on a signal received from the user input device 130.

In this case, the change from the first view mode to the second view mode may include a change from a single view mode to a multi view mode, a change from a multi view mode to a single view mode, and a change from a multi view mode to a multi view mode, but is not limited thereto.

In operation S330, the display device 1000 may provide recommended content in the second view mode based on a result of analyzing the first content. In the case where the second view mode is the dual view mode, the display device 1000 may display the first content in a first region of the dual view mode, and provide the recommended content corresponding to the first content in a second region of the dual view mode.

Also, the display device 1000 may change an attribute of the second view mode that provides the recommended content. The changeable attribute of the second view mode may include a size, a location, transparency of a region in which the recommended content is provided, a format, color, etc. in which the recommended content is displayed, but is not limited thereto. For example, the format in which the recommended content is displayed may include a list, a grid, a web page, a pop-up, notification, a custom format, etc., but is not limited thereto.

The display device 1000 may change a sorting sequence of the recommended content according to a user setting. For example, the display device 1000 may sort the recommended content in a sequence where similarity to the first content is high, or sort the recommended content in a time sequence in which the recommended content is updated, but is not limited thereto.

Also, the display device 1000 may automatically launch the recommended content. For example, in the case where the recommended content is an application, the launching of the content may include installing and executing, at the display device 1000, the application. Also, in the case where the recommended content is broadcast content, the launching of the content may include reproducing, at the display device 1000, the recommended content, but is not limited thereto.

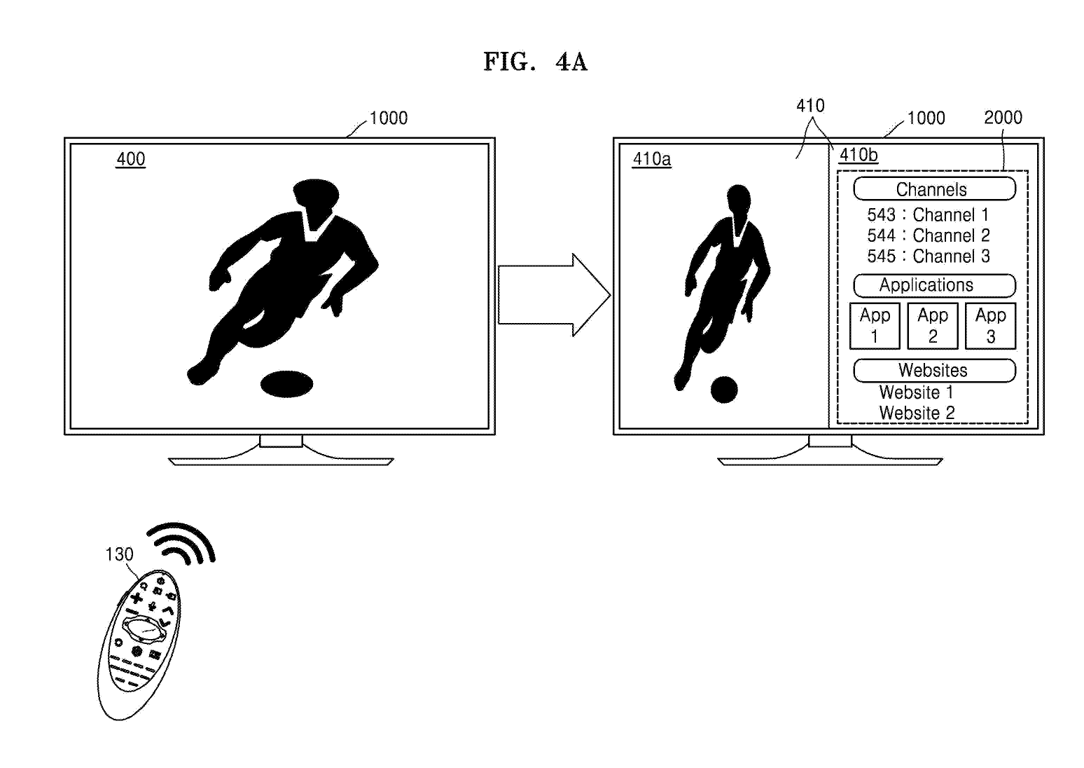

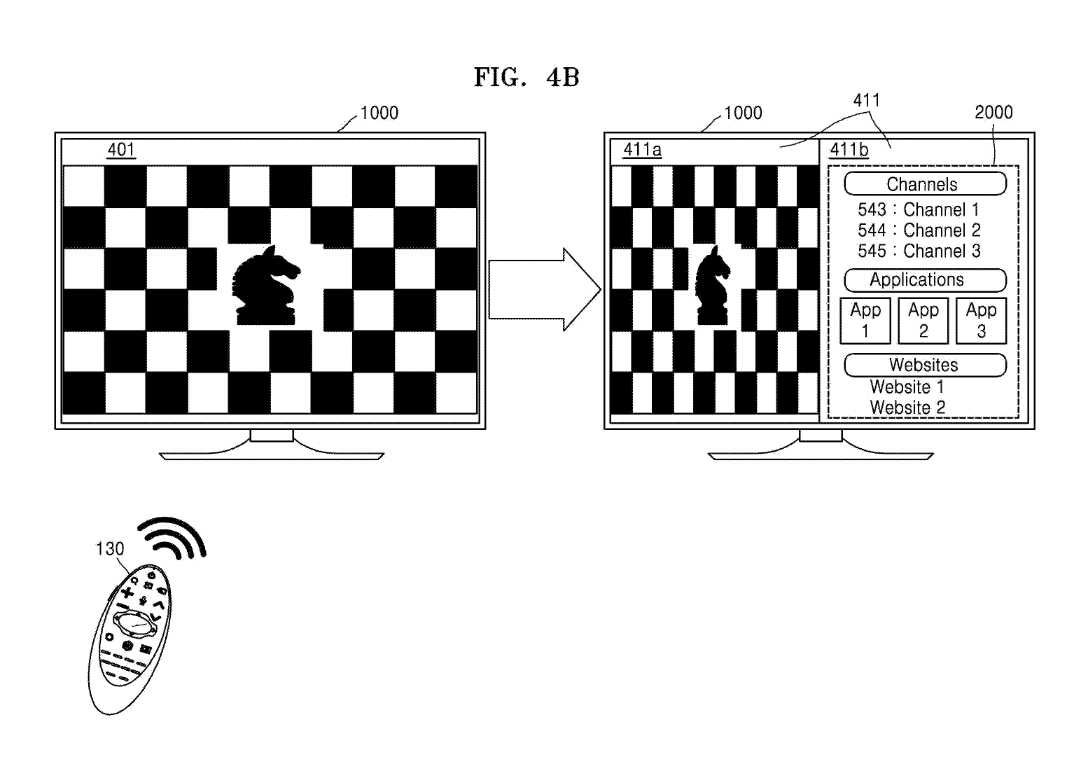

FIGS. 4A and 4B are diagrams illustrating an example in which a display device 1000 provides recommended content according to an exemplary embodiment.

Referring to FIG. 4A, the display device 1000 may display first content in a first mode 400. For example, as illustrated in FIG. 4A, the first mode 400 may be a single view mode but is not limited thereto.

When detecting a change from the first mode 400 to a second mode 410, the display device 1000 may provide recommended content 2000 in the second mode 410. In this case, the second mode 410 may be a double view mode as illustrated in FIG. 4A, but is not limited thereto.

Referring to FIG. 4A, in the second mode 410, the screen may include a first region 410a and a second region 410b.

Also, the display device 1000 may display the first content in the first region 410a, and provide the recommended content 2000 in the second region 410b based on a result of analyzing the first content. The recommended content 2000 may include a recommended channel, a recommended application, a recommended website, etc. as illustrated in FIG. 4A, but is not limited thereto.

For example, as illustrated in FIG. 4A, when the first content is broadcast content related to a soccer, recommended channels 543 to 545 may be channels related to FIFA World Cup, and global soccer news. Also, recommended applications App1 to App3 may include a soccer game application, an application providing a soccer relay service, etc., but are not limited thereto.

The display device 1000 may display an execution screen of an application in a first mode 401 according to an exemplary embodiment. For example, as illustrated in FIG. 4B, the display device 1000 may display an execution screen of a chess game application in the first mode 401.

After that, when a detecting change from the first mode 401 to a second mode 411, the display device 1000 may provide recommended content 2000 corresponding to the chess game in the second mode 411.

According to an exemplary embodiment, the display device 1000 may provide content having a type different from that the type of the first content as recommended content. For example, as illustrated in FIG. 4A, in the case where the first content is broadcast content, the recommended content may include an application or a website, etc. Also, as illustrated in FIG. 4B, in the case where second content is an application, recommended content may include broadcast content or a website, etc., but is not limited thereto.

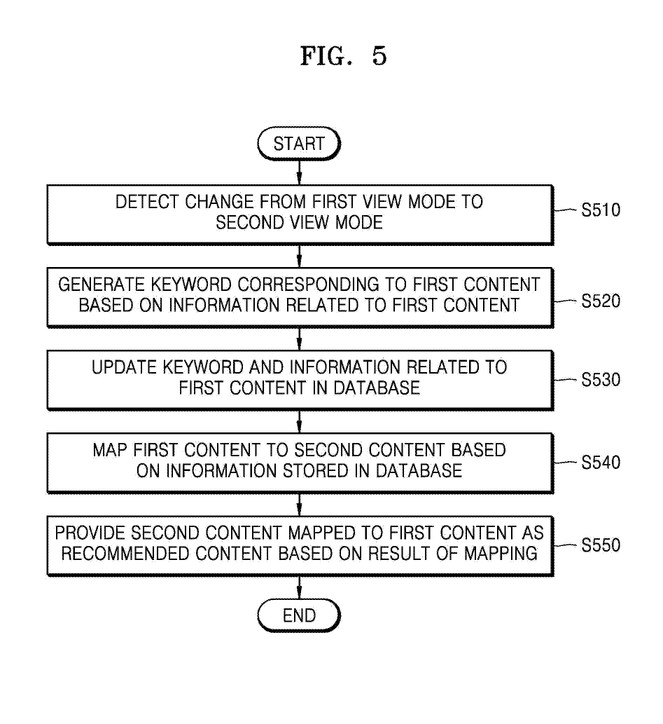

FIG. 5 is a flowchart illustrating a process of providing recommended content at a display device 1000 according to an exemplary embodiment.

When detecting a change from the first view mode to the second view mode (operation S510), the display device 1000 may analyze first content (operation S520).

For example, the display device 1000 may analyze an electronic program guide (EPG) and extract information related to the first content from the EPG. Here, the EPG may denote a broadcasting program guide service that provides information such as a TV program broadcasting time and content, etc. by using a frequency band or an additional channel not used by TV broadcasting. The information related to the first content may include a program name, a channel name, a genre, metadata, etc., but is not limited thereto.

Also, the display device 1000 may generate a keyword corresponding to the first content based on the information related to the first content. For example, in the case where the first content is broadcast content related to a World Cup soccer game, a keyword corresponding to the first content may include “FIFA World Cup”, “sports”, “soccer”, etc., but is not limited thereto.

In operation S530, the display device 1000 may update the information related to the first content and the generated keyword in a database. In this case, the information related to the first content and the keyword may be updated as first information in the database.

The display device 1000 may update the database whenever the first content displayed in the first view mode changes. Alternatively, according to an exemplary embodiment, the display device 1000 may update the database at a predetermined time interval.

In operation S540, the display device 1000 may map the first content to second content based on information stored in the database.

The second content may denote all content available at the display device 1000. Also, the second content may include broadcast content, web content, and an application stored in a cloud/server and an external storage device.

The database may include the first information including the information related to the first content and the keyword, and second information including information related to the second content and a keyword.

The second information may be stored in the database in advance before the change of the view mode is detected. Also, according to an exemplary embodiment, the display device 1000 may update the second information in the database whenever the information related to the second content changes, or update the database at a predetermined time interval.

The display device 1000 may map the first content to the second content based on the first information and the second information. In this case, the display device 1000 may map one first content to a plurality of second content. For example, in the case where the first content is broadcast content, the display device 1000 may map the first content to at least one of broadcast content, an application, and web content that are different from the first content. Also, in the case where the first content is an application, the display device 1000 may map the first content to at least one of an application, broadcast content, and web content that are different from the first content.

Also, the display device 1000 may map the first content to the second content based on similarity between the first content and the second content. For example, when at least two keywords corresponding to the first content and the second content coincide, the display device 1000 may determine the first content is similar to the second content, but is not limited thereto.

A criterion determining similarity between the first content and the second content may change depending on user setting.

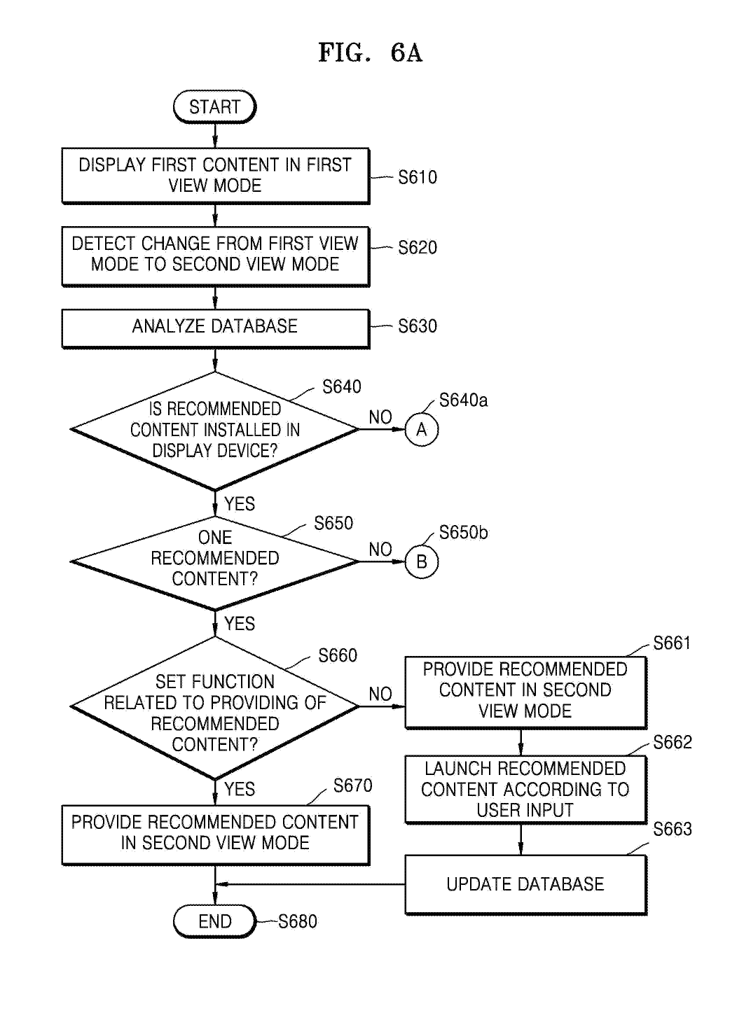

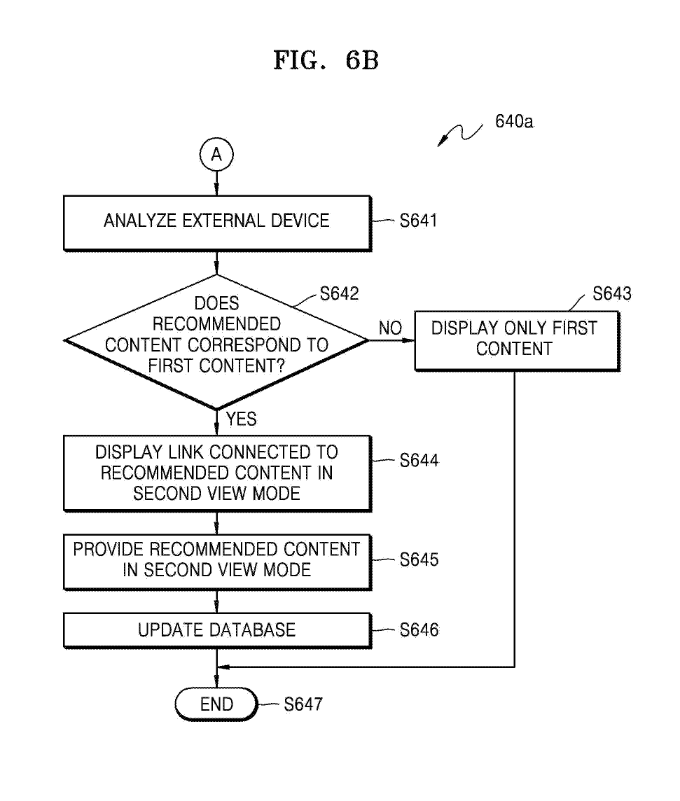

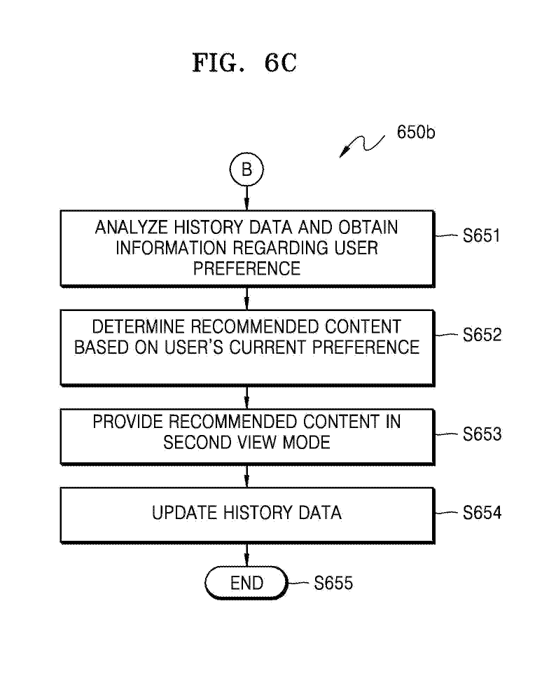

FIGS. 6A to 6C are flowcharts illustrating more specifically a display method according to an exemplary embodiment. FIGS. 6A to 6C exemplarily describe the case where recommended content is an application. Since a flowchart representing the display method has been described in detail with reference to FIGS. 3 and 5, repeated description is omitted.

Operations S610 to S630 illustrated in FIG. 6A may correspond to a portion of operations S310, S320, and S330 illustrated in FIG. 3.

In operation S640, the display device 1000 may determine whether recommended content determined based on a result of analyzing a database has been installed in the display device 1000 or stored in the display device 1000.

When the recommended content is not installed or stored in the display device 1000 (operation S640a), the display device 1000 may provide content stored in an external server or an external storage medium, etc. as recommended content. Hereinafter, for convenience in description, an external server or an external storage medium, etc. is referred to as an external device. Operation of providing content stored in the external device as recommended content is described with reference to FIG. 6B.

When the recommended content is installed or stored in the display device 1000, the display device 1000 may determine whether the recommended content includes plural pieces of content (operation S650).

When the recommended content includes plural pieces of content (operation S650b), the display device 1000 may determine the recommended content to display in the second view mode based on a user's preference. The determining of the recommended content based on the user's preference is described below with reference to FIG. 6C.

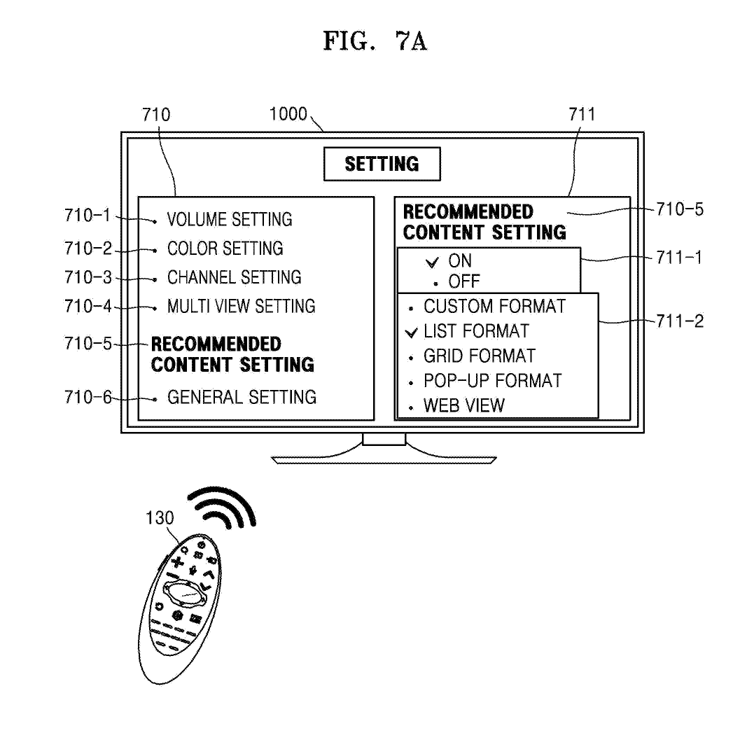

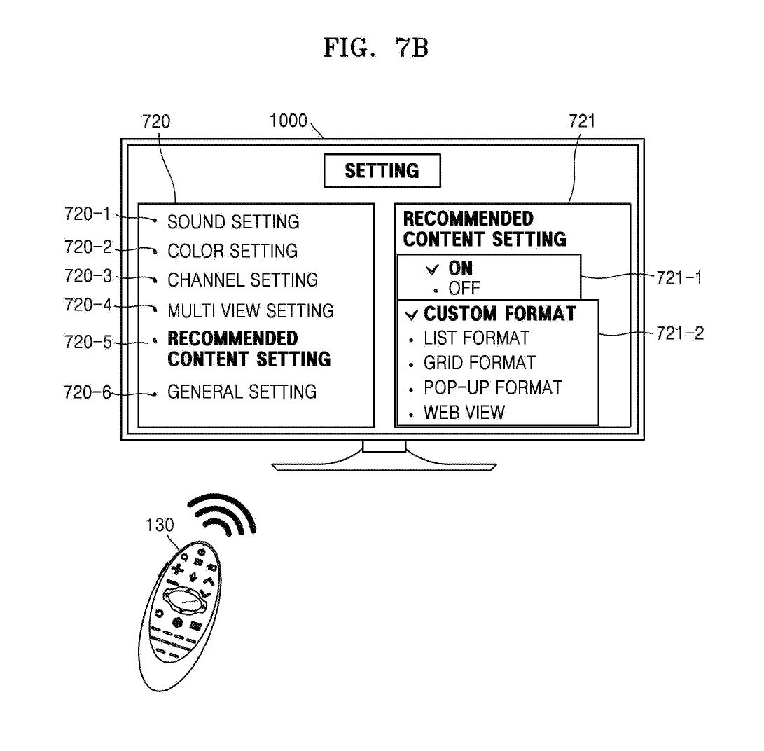

In the case where the recommended content includes one piece of content, the display device 1000 may set a function related to providing the recommended content (operation S660), and provide the recommended content in the second view mode (operation S670). The setting of the function related to the providing of the recommended content is described later with reference to FIGS. 7A and 7B.

Alternatively, the display device 1000 may provide the recommended content to a user (operation S661), and launch the recommended content according to a user input (operation S662). In the case where the recommended content is an application, the launching may include installing or executing the recommended content.

Also, as the recommended content is launched, the display device 1000 may update a database (operation S663). For example, the display device 1000 may update changed second information in the database.

FIGS. 6B and 6C are operations subsequent to operations illustrated in FIG. 6A.

Referring to FIG. 6B, when determining that the recommended content is not installed or stored in the display device 1000 (operation S640a), the display device 1000 may provide the recommended content from an external device.

The display device 1000 may analyze at least one external device (operation S641), and determine whether the recommended content corresponds to the first content based on a result of the analyzing (operation S642).

When the recommended content corresponds to the first content, the display device 1000 may display a link connected to the recommended content (operation S644), and provide the recommended content in the second view mode (operation S645).

Also, in operation S646, the display device 1000 may update the database.

When the recommended content does not correspond to the first content, the display device 1000 may not provide the recommended content and may provide only the first content (operation S643). In this case, according to an exemplary embodiment, the display device 1000 may change from the second view mode to the first view mode, and display the first content in the first view mode. Also, in the case where the second view mode is the dual view mode, the display device 1000 may display the first content in the first region, and display a message representing there is no recommended content in the second region, but is not limited thereto.

Referring to FIG. 6C, according to an exemplary embodiment, the display device 1000 may determine the recommended content based on a user's preference. For example, in the case where the recommended content is the plural in operation S650 illustrated in FIG. 6A (operation S650b), the display device may determine recommended content to display in the second view mode based on the user's preference.

In operation S651, the display device 1000 may analyze history data. The history data may include information regarding content selected from the display device 1000 by a user. Also, the display device 1000 may obtain information regarding the user's preference based on a result of analyzing the history data.

In operation S652, the display device 1000 may determine recommended content based on the obtained information regarding the user's preference. For example, when a user prefers a video-based application to a graphic-based application, the display device 1000 may determine recommended content corresponding thereto.

In operation S653, the display device 1000 may provide the recommended content determined in operation S652 in the second view mode.

In operation S654, the display device 1000 may update the history data.

FIGS. 7A and 7B are diagrams illustrating an example in which the display device 1000 sets an item related to providing of recommended content according to an exemplary embodiment.

The display device 1000 may turn on and off a function of providing recommended content based on a user input.

Referring to FIG. 7A, the display device 1000 may display a setting table 710 as a user interface that may set various items related to the display device 1000. For example, as illustrated in FIG. 7A, the setting table 710 may include a volume setting 710-1, a color setting 710-2, a channel setting 710-3, a multi view mode setting 710-4, a recommended content setting 710-5, a general setting 710-6, etc., but is not limited thereto.

Also, when an item to set is selected according to a user input, the display device 1000 may display options related to the selected item.

According to an exemplary embodiment, the display device 1000 may display the options related to the selected item in a region 711 discriminated from the setting table 710.

Referring to FIG. 7A, when the recommended content setting 710-5 is selected from the setting table 710, the display device 1000 may display options related to a function of providing recommended content in the region 711 discriminated from the setting table 710. For example, the options related to the function of providing the recommended content may include an on and off function 711-1 that activates or deactivates the function of providing the recommended content, a type 711-2 in which the provided recommended content is displayed, etc., but is not limited thereto.

Referring to FIG. 7A, the display device 1000 may display the recommended content in a list format according to a user input that selects the list format.

Also, referring to FIG. 7B, the display device 1000 may display the recommended content in a custom format according to a user input. In this case, the user input may be received from the user input device 130, but is not limited thereto. When the custom format is selected, the display device 1000 may further receive a user input for determining the custom format. For example, the display device 1000 may determine a size, a location, transparency, color, etc. of a region in which the recommended content is displayed based on a user input received from the user input device 130, but is not limited thereto.

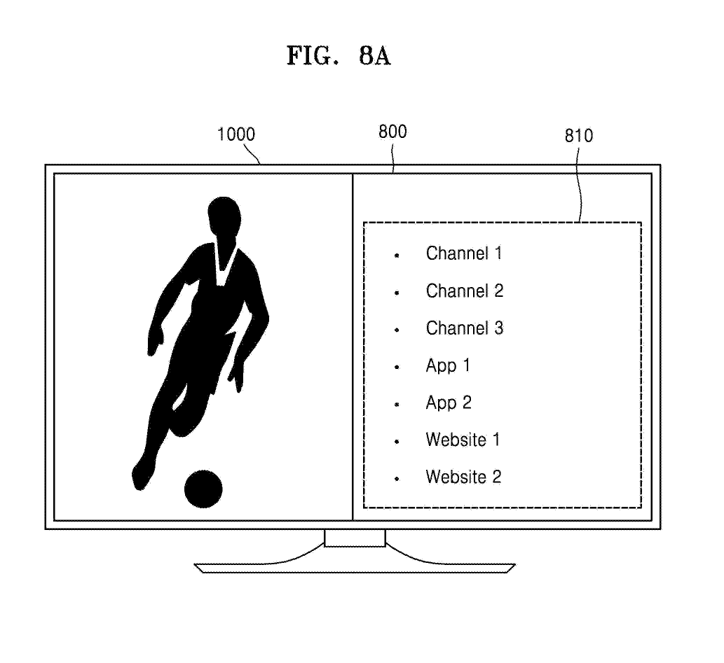

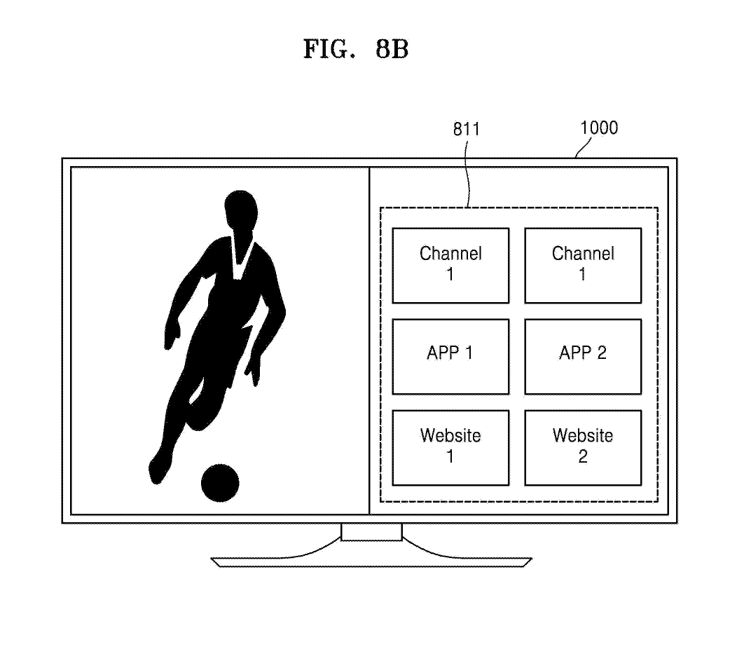

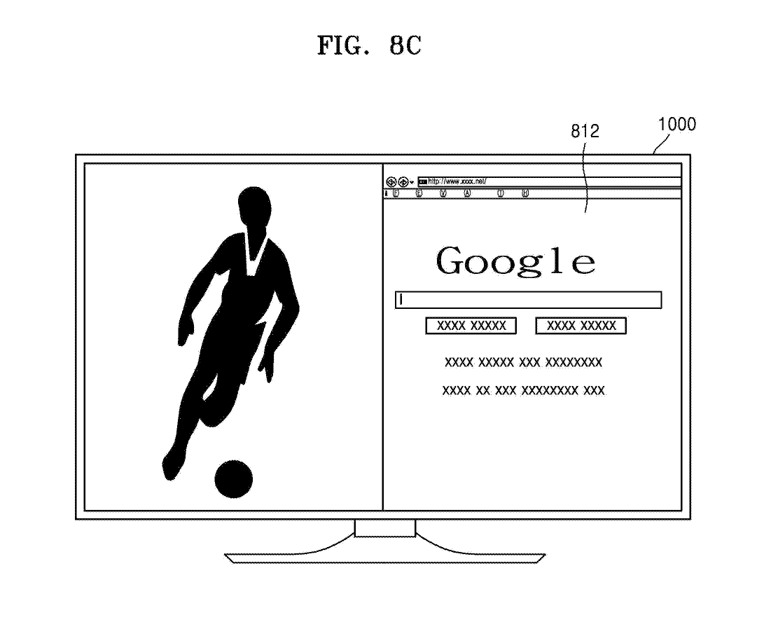

FIGS. 8A to 8C are diagrams illustrating a format in which a display device 1000 displays recommended content according to an exemplary embodiment.

For example, in the case where a list format is selected, the display device 1000 may display recommended content 810 in the list format as illustrated in FIG. 8A. Referring to FIG. 8A, the display device 1000 may display the recommended content 810 such as a recommended channel, a recommended application, and a recommended website in the list format in a second view mode 800.

Also, the display device 1000 may display recommended content 811 in a grid format. The grid format may denote displaying the recommended content 811 in a grid shape. As illustrated in FIG. 8B, the display device 1000 may display each of the recommended content 811 in a quadrangular shape, but is not limited thereto.

Also, as illustrated in FIG. 8C, the display device 1000 may display recommended content 812 in a web page format. For example, in the case where the recommended content is an application, the display device 1000 may display a web page from which a recommended application may be downloaded. Also, in the case where a plurality of recommended content is provided, the display device 1000 may display the recommended content in a format of a web page including a plurality of taps.

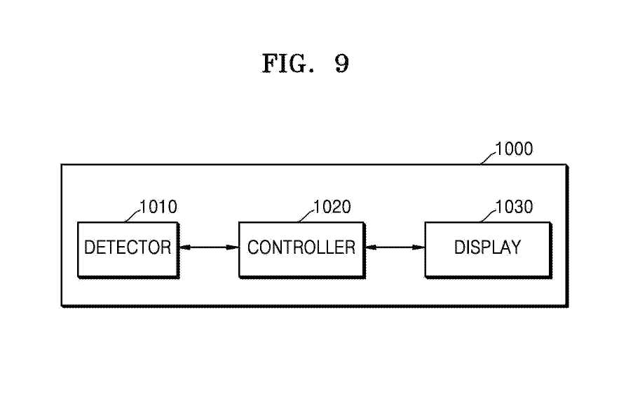

FIGS. 9 to 11 are block diagrams illustrating a construction of a display device 1000 according to an exemplary embodiment.

As illustrated in FIG. 9, the display device 1000 according to an exemplary embodiment may include a detector 1010, a controller 1020, and a display 1030. However, the illustrated components are not all essential components. The display device 1000 may include the number of components greater than the number of illustrated components, or include the number of components less than the number of illustrated components.

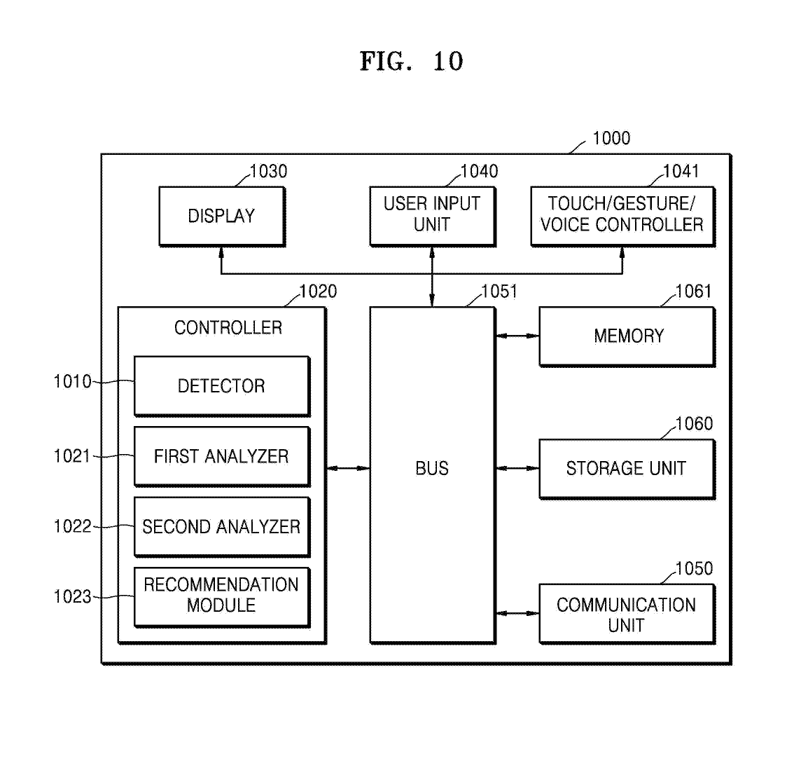

For example, as illustrated in FIG. 10, the display device 1000 may further include a user input unit 1040, a touch/gesture/voice controller 1041, a communication unit 1050, a bus 1051, a storage unit 1060, and a memory 1061.

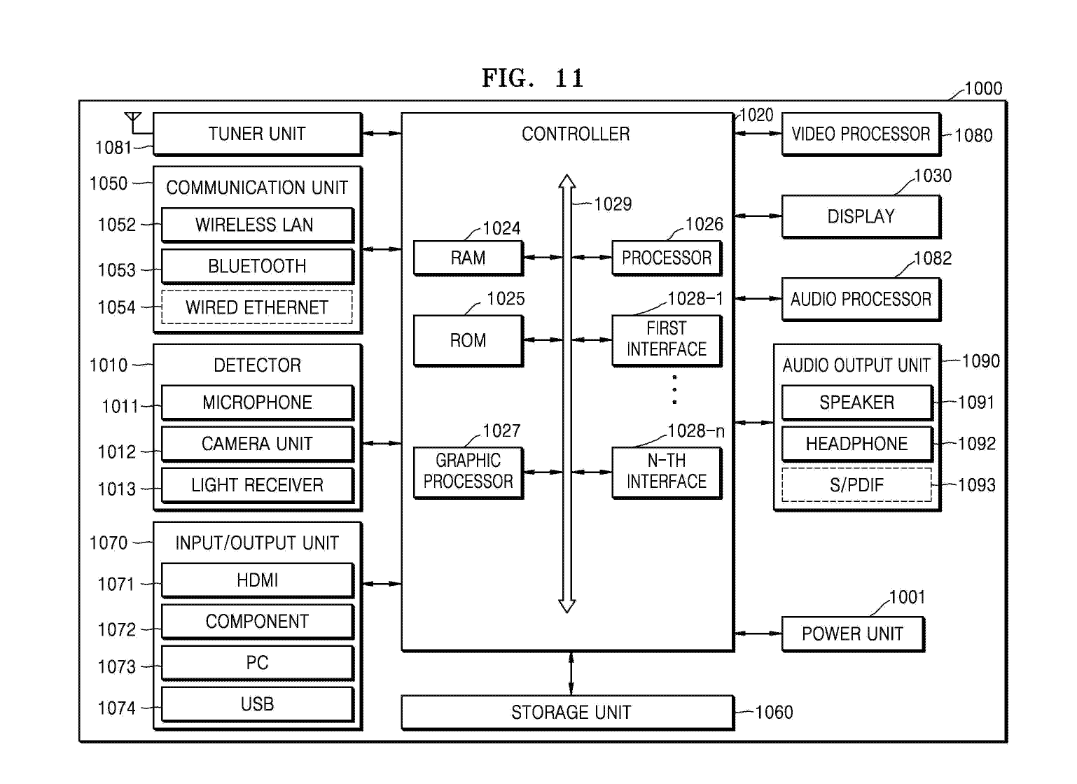

Alternatively, according to an exemplary embodiment, as illustrated in FIG. 11, the display device 1000 may further include a tuner unit 1081, an input/output unit 1070, a video processor 1080, an audio processor 1082, an audio output unit 1090, and a power unit 1001.

The above components are described below.

The detector 1010 may detect a user input and transfer a detected signal corresponding to the user input to the controller 1020.

Also, the detector 1010 may detect a user input that changes a view mode of the display device 1000. For example, when detecting a signal that changes from a first view mode to a second view mode, the detector 1010 may transfer the detected signal to the controller 1020.

The change of the view mode may be performed according to various events. For example, the change of the view mode may be performed when a user input is detected, and may be performed according to a setting designated in advance by a user. Alternatively, the change of the view mode may be performed according to basic settings of the display device 1000, but is not limited thereto.

According to an exemplary embodiment, the detector 1010 may include a microphone 1011, a camera unit 1012, and a receiver 1023, but is not limited thereto.

The microphone 1011 may receive an external voice signal, convert the received external voice signal into an electric signal, and output the electric signal to the controller 1020. In this case, the voice signal may include voice corresponding to a menu or a function of the display device 1000.

Also, the microphone 1011 may be implemented integrally with or separately from the display device 1000. The separated microphone 1011 may be electrically connected with the display device 1000 via the communication unit 1050 or the input/output unit 1070.

The camera unit 1012 receives an image (for example, a successive image frame) corresponding to a user's motion including a gesture in a recognition range of a camera. For example, the user's motion may include motion of a portion of a user or a user's body such as a user's face, look, hand, fist, and finger. The camera unit 1012 may convert a received image into an electric signal and output the electric signal to the controller 1020 under control of the controller 1020.

Then, the controller 1020 may select a menu displayed on the display device 1000 by using a result of recognizing the received motion, or perform a control corresponding to the result of recognizing the received motion. For example, the control may include channel adjustment, volume adjustment, and cursor movement.

The camera unit 1012 may be implemented integrally with or separately from the display device 1000. A separate device including the separated camera unit 1012 may be electrically connected with the display device 1000 via the communication unit 1050 or the input/output unit 1070.

According to an exemplary embodiment, the camera unit 1012 may include two or more cameras. In the case where the camera unit 1012 includes a plurality of cameras, the camera unit 1012 may receive a three-dimensional still image or a three-dimensional motion by using the plurality of cameras.

A light receiver 1013 receives a light signal (including a control signal) received from the external user input device 130 via a window of a bezel of the display 1030. The light receiver 1013 may receive a light signal corresponding to a user input (for example, a touch, a pressing, a touch gesture, voice, or motion) from the user input device 130. Also, a control signal may be extracted from the received light signal under control of the controller 1020.

According to an exemplary embodiment, the detector 1010 may be configured separately from the controller 1020, or included in the controller 1020 as illustrated in FIG. 10.

The controller 1020 controls an overall operation of the display device 1000. For example, the controller 1020 may generally control the display 1030, the communication unit 1050, the input/output unit 1070, etc. by executing programs stored in the memory 1061.

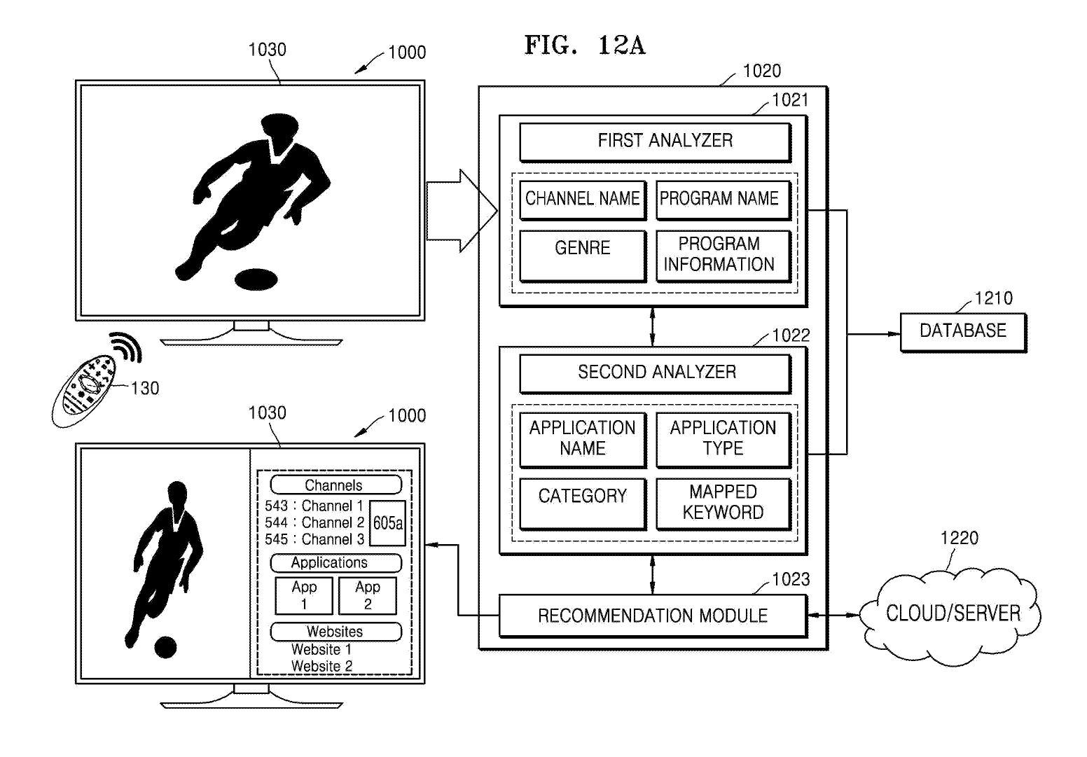

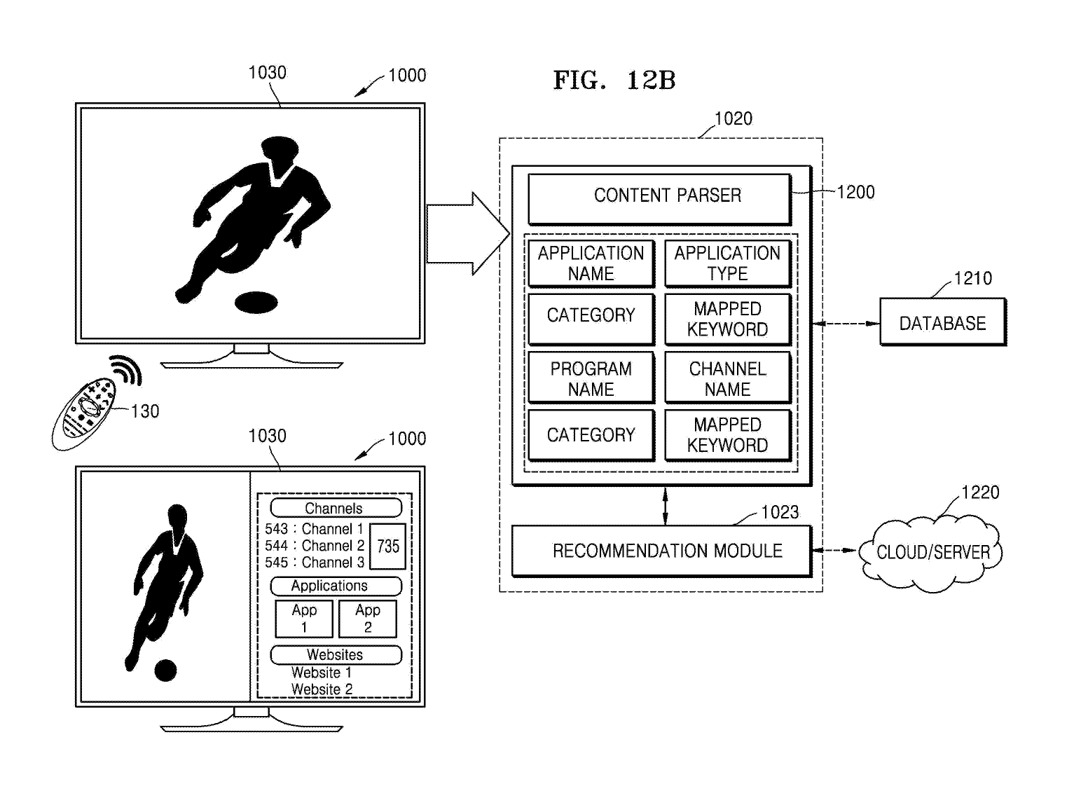

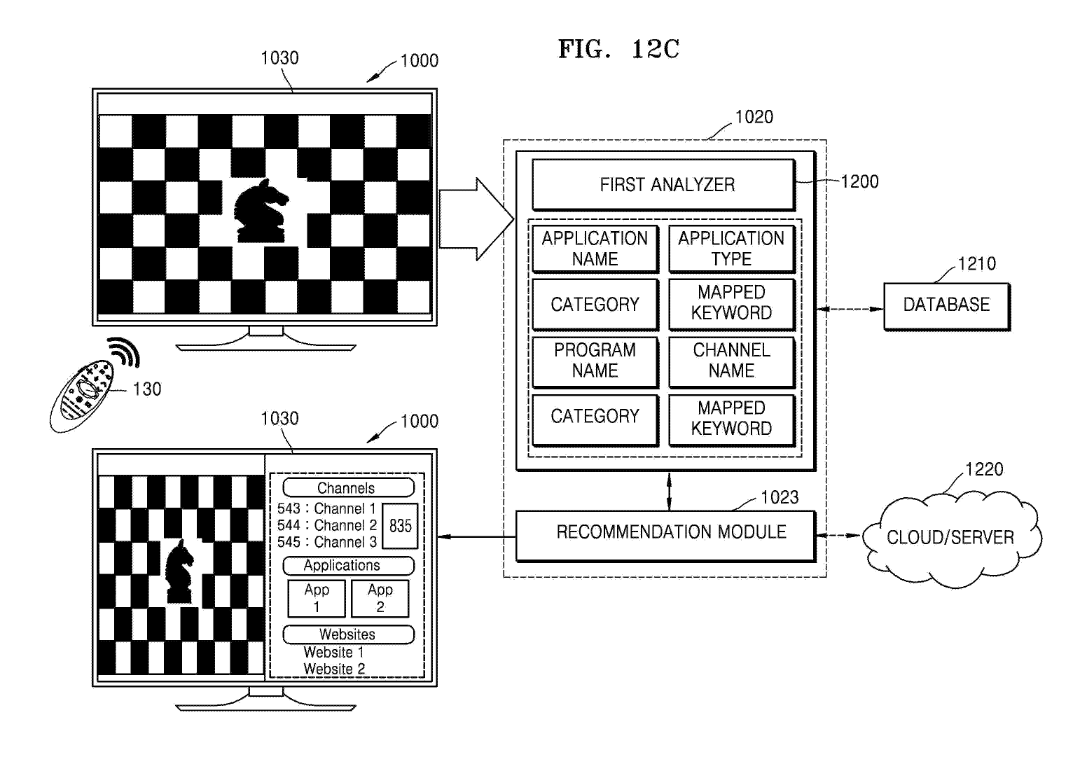

The controller 1020 may analyze first content displayed in the first view mode, and control to provide recommended content in the second view mode based on a result of analyzing the first content. In this case, according to an exemplary embodiment, the controller 1020 may include a first analyzer, a second analyzer, and a recommendation module, which are described with reference to FIGS. 12A to 12C.

Also, according to an exemplary embodiment, the controller 1020 may include a random-access memory (RAM) 1024, a read-only memory (ROM) 1025, a processor 1026, a graphic processor 1027, and first to n-th interfaces 1028-1 to 1028-n. The RAM 1024 may be used as a storage region required for storing a signal or data input from the outside of the display device 1000, or performing various operations at the display device 1000. The ROM 1025 may store a program for controlling the display device 1000.

The processor 1026 may include a graphic processing processor (GPU) for processing graphics corresponding to a video. The processor 1026 may be implemented as a system on chip (SoC) integrating a core and the GPU. The processor 1026 may include a single core, a dual core, a triple core, a quad core, and a multiple core thereof.

Also, the processor 1026 may include a plurality of processors. For example, the processor 1026 may be implemented as a main processor and a sub processor that operates in a sleep mode.

The graphic processor 1027 generates a screen including various objects such as an icon, an image, and text by using an operator and a renderer. The operator operates an attribute value such as a coordinate value, a shape, a size, and color in which respective objects are to be displayed depending on a layout of the screen by using a user input detected via the detector 1010. The renderer generates the screen of various layouts including an object based on the attribute value operated by the operator. The screen generated by the renderer is displayed on the display 1030.

The first to n-th interfaces 1028-1 to 1028-n are connected with the above-described various components. One of the interfaces may be a network interface connected with an external device via a network.

The RAM 1024, the ROM 1025, the processor 1026, the graphic processor 1027, and the first to n-th interfaces 1028-1 to 1028-n may be connected with each other via an internal bus 1029.

The controller 1020 illustrated in FIGS. 10 and 11 may be an exemplary embodiment of the controller 1020 illustrated in FIG. 9.

The display 1030 may display information processed by the display device 1000. For example, the display 1030 may display broadcast content, web content, an application, etc.

Also, the display 1030 may display content in a first view mode or a second view mode depending on a user input.

The display 1030 may display first content in the first view mode. Also, when detecting a signal that changes from the first view mode to the second view mode, the display 1030 may display recommended content in the second view mode. In this case, the recommended content may be content recommended based on a result of analyzing the first content.

Also, the display 1030 may display a setting menu for controlling various functions of the display device 1000.

The display 1030 may include at least one of a liquid crystal display (LCD), a thin film transistor-liquid crystal display (TFT-LCD), an organic light-emitting diode (OLED), a flexible display, a 3-dimensional (3D) display, and an electrophoretic display. Also, depending on an implementation type of the display device 1000, the display device 1000 may include two or more displays 1030.

Also, in the case where the display 1030 and a touchpad are configured as a touchscreen by forming a layer structure, the display 1030 may be used as an input unit as well as an output unit.

The user input unit 1040 denotes a unit that inputs a signal for controlling the display device 1000. In this case, according to an exemplary embodiment, the user input unit 1040 may be a component of the display device 1000, or the user input device 130 independent of the display device 1000.

For example, the user input unit 1040 may be a device independent of the display device 1000 such as a remote controller and a mouse. Also, the user input unit 1040 may be a device included in the display device 1000 such as a touchpad, a gesture, a voice control, a touch ball, an attentive user interface (AUI), a text-based interface, a mouse, and a cursor directional key for controlling motion of a cursor on the display 1030, but is not limited thereto.

Also, according to an exemplary embodiment, the display device 1000 may further include a touch/gesture/voice controller 1041 for controlling a touch, a gesture, and a user's voice as illustrated in FIG. 10.

The tuner unit 1081 may tune and select only a frequency of a channel that the display device 1000 desires to receive among lots of radio wave components by using amplification, mixing, resonance, etc. of broadcasting signals received via a wired line or wirelessly. The broadcasting signals include audio, video, and additional information (for example, EPG).

The tuner unit 1081 may receive broadcasting signals from a frequency band corresponding to a channel number according to a control signal (for example, a channel number input, an up-down input of a channel, and a channel input on an EPG screen) received from the user input unit 1040.

The tuner unit 1081 may receive broadcasting signals from various sources such as ground wave broadcasting, cable broadcasting, satellite broadcasting, and Internet broadcasting. The tuner unit 1081 may receive broadcasting signals from a source such as analog broadcasting or digital broadcasting. Broadcasting signals received via the tuner unit 1081 are decoded (for example, audio decoding, video decoding, or additional information decoding) and separated into audio, video, and/or additional information. The separated audio, video, and/or additional information may be stored in the storage unit 1060 under control of the controller 1020.

The tuner unit 1081 of the display device 1000 may be one or the plural. The tuner unit 1081 may be implemented integrally with the display device 1000, or may be implemented as a separate unit (for example, a set-top box, and a tuner unit connected to the input/output unit 1070) including a tuner unit electrically connected with the display device 1000.

The communication unit 1050 may connect the display device 1000 with an external device (for example, an audio device, etc.). The controller 1020 may transmit/receive content to/from an external device connected via the communication unit 1050, and download an application from an external device, or perform web browsing. The communication unit 1050 may include at least one of a wireless local area network (LAN) 1052, a Bluetooth 1053, a wired Ethernet 1054 depending on the performance and structure of the display device 1000.

The communication unit 1050 may receive a control signal from the user input device 130 under control of the controller 1020. A control signal may be implemented as a Bluetooth type signal, an radio frequency (RF) type signal, or a wireless fidelity (Wi-Fi) type signal.

For example, the communication unit 1050 may receive a signal corresponding to a Bluetooth type user input (for example, a touch, a pressing, a touch gesture, voice, or motion) from the user input device 130 via the Bluetooth communication 1053.

The communication unit 1050 may further include other short distance communication (for example, near field communication (NFC), and Bluetooth low energy (BLE)) besides the Bluetooth 1053.

The storage unit 1060 may store various data, a program, or an application that drives or controls the display device 1000. The storage unit 1060 may store an input/output signal or data required for driving the video processor 1080, the display 1030, the audio processor 1082, the audio output unit 1090, the power unit 1001, the tuner unit 1081, the communication unit 1050, the detector 1010, and the input/output unit 1070.

Also, the storage unit 1060 may store a control program that controls the display device 1000, an application provided by a manufacturer, or downloaded from the outside, user information, a document, a database, etc.

According to an exemplary embodiment, the display device 1000 may further include the memory 1061 that stores temporarily required data as illustrated in FIG. 10.

Also, according to an exemplary embodiment, a term “storage unit” may include the storage unit 1060, the RAM 1024 and the ROM 1025 of the controller 1020 illustrated in FIG. 11.

The video processor 1080 processes video data received by the display device 1000. The video processor 1080 may perform various image processes such as decoding, scaling, noise filtering, frame rate conversion, and resolution conversion on video data.

The audio processor 1082 processes audio data. The audio processor 1082 may perform various processes such as decoding or amplification, and noise filtering on audio data. Meanwhile, the audio processor 1082 may include a plurality of audio process modules in order to process audio corresponding to a plurality of content.

The audio output unit 1090 may output audio included in a broadcasting signal received via the tuner unit 1081 under control of the controller 1020. The audio output unit 1090 may output audio (for example, voice, a sound) input via the communication unit 1050 or the input/output unit 1070. Also, the audio output unit 1090 may output audio stored in the storage unit 1060 under control of the controller 1020. The audio output unit 1090 may include at least one of a speaker 1091, a headphone output terminal 1092, and a Sony/Philips digital interface (S/PDIF) output terminal 1093. The audio output unit 1090 may include a combination of the speaker 1091, the headphone output terminal 1092, and the S/PDIF output terminal 1093.

The power unit 1001 may supply power output from an external power source to the components inside the display device 1000 under control of the controller 1020. Also, the power unit 1001 may supply power output from one or more batteries located inside the display device 1000 to the components inside the display device 1000 under control of the controller 1020.

The input/output unit 1070 receives video (for example, a moving picture, etc.), audio (for example, voice, music, etc.), and additional information (for example, an EPG, etc.) from the outside of the display device 1000 under control of the controller 1020. The input/output unit 1070 may include at least one of a high-definition multimedia interface (HDMI) port 1071, a component jack 1072, a PC port 1073, and a universal serial bus (USB) port 1074. The input/output unit 1070 may include a combination of the HDMI port 1071, the component jack 1072, the PC port 1073, and the USB port 1074.

FIGS. 12A to 12C are block diagrams illustrating a construction of a controller 1020 according to an exemplary embodiment. The controller 1020 may be implemented as a computing device or a signal processor.

Referring to FIG. 12A, the controller 1020 may control the display 1030 to display recommended content in the second view mode based on a result of analyzing first content. In this case, according to an exemplary embodiment, the controller 1020 may include a first analyzer 1021, a second analyzer 1022, and a recommendation module 1023.

The first analyzer 1021 may analyze the first content displayed in the first view mode. For example, the first analyzer 1021 may analyze an EPG and extract information related to the first content from the EPG when the first content is broadcast content.

The first analyzer 1021 may generate first information based on the extracted information. For example, as illustrated in Table 1, in the case where the first content is a World Cup game broadcasted via CHANNEL 1, the first information may include a program name, a channel name, a genre, a keyword, description of the first content, etc., but is not limited thereto.

TABLE 1

| Program | FIFA World Cup |
|---|---|
| Channel | CHANNEL 1 |
| Genre | Sports, soccer |
| Keyword | Soccer, Brazil, World Cup |
| Description | Brazil vs Germany, |
| | Semi-final game held in Rio de Janerio |

The first analyzer 1021 may be located in at least one of the display device 1000 and a cloud/server 1220.

The second analyzer 1022 may analyze a plurality of content stored in the display device 1000, the cloud/server 1220, and an external storage device. In the case where content to analyze is an application, the second analyzer 1022 may analyze a configuration file located inside the application. In this case, the configuration file may include information regarding the application in at least one format among a rich site summary (RSS) format, an extensible markup language (XML) format, a hypertext markup language (HTML) format, and a text format.

Also, the second analyzer 1022 may extract information related to the application from the configuration file, and generate second information. In this case, as illustrated in Table 2, the second information may include an application name, a type, a category, and description, but is not limited thereto.

TABLE 2

| Application name | Type | Category | Description |
|---|---|---|---|
| APP1 | News | Sports | Real-time soccer news |
| APP2 | VOD | Video | U.S. drama |
| APP3 | 3D game | Game | Action game |
| APP4 | 2D game | Game | Basketball game |
| APP5 | Video | Video | On-line video |

As such, when the first content corresponds to an application program, the first analyzer 1021 may analyze properties or attributes of the application program and extract information from the properties or attributes. According to another exemplary embodiment, when the first content corresponds to a webpage, the first analyzer 1021 may analyze meta elements or meta tags of the webpage and extract information from the meta elements or meta tags.

The second analyzer 1022 may update the second information in a database.

The controller 1021 may determine whether the type of the first content corresponds to one of a broadcast content type, an application program type, and a webpage type. If the controller 1020 determines that the type of the first content corresponds to the broadcast content type, the controller 1020 may analyze the first content through the first analyzer 1021. The first analyzer 1021 may generate a keyword from an electronic program guide of the first content. If the controller 1020 determines that the type of the first content corresponds to the application program type or the webpage type, the controller 1020 may analyze the first content through the second analyzer 1022. The second analyzer 1022 may generate a keyword from a property or an attribute of the first content if the first content corresponds to the application program type. The second analyzer 1022 may generate a keyword from a meta element or a meta tag of the first content if the type of the first content corresponds to the webpage type.

The recommendation module 1023 may analyze the first information and the second information. Also, the recommendation module 1023 may map the first content to second content based on a result of analyzing the first and second information. In this case, the recommendation module 1023 may map a plurality of second content to one first content.

Also, the recommendation module 1023 may provide the mapped second content as recommended content based on a result of the mapping. Accordingly, the display 1030 may display the recommended content provided by the recommendation module 1023 in the second view mode.

Also, the recommendation module 1023 may be implemented in at least one of the display device 1000 and an external server. In the case where the recommendation module 1023 is implemented in the display device 1000, the recommendation module 1023 may recommend content stored in advance in the display device 1000.

According to an exemplary embodiment, the controller 1020 may include a content parser 1200 and a recommendation module 1023. In this case, the content parser 1200 may correspond to the first analyzer 1021 and the second analyzer 1022 illustrated in FIG. 12A.

Referring to FIG. 12B, the content parser 1200 may generate first information by parsing the first content displayed in the first mode. Also, the content parser 1200 may generate second information by parsing a plurality of second content stored in one of the display device 1000, the cloud/server 1220, and the external storage device. Since the process of generating the first information and the second information has been described in detail with reference to FIG. 11, description thereof is omitted.

Referring to FIG. 12C, in the case where the first content is an application, recommended content provided by the recommendation module 1023 may be at least one of an application different from the first content, broadcast content, and web content, but is not limited thereto.

Also, according to an exemplary embodiment, the controller 1020 may provide content having a type different from the type of the first content as recommended content. For example, as illustrated in FIG. 12C, in the case where the first content is an application, the recommended content may include broadcast content or web content, but is not limited thereto.

The methods according to some exemplary embodiments may be embodied in the form of program commands executable through various computer means, which may be recorded on a computer-readable recording medium. The computer-readable recording medium may include program commands, data files, and data structures either alone or in combination. The computer-readable recording medium is any data storage device that can store data that can be thereafter read by a computer system. Examples of the computer-readable recording medium include magnetic recording media such as hard disks, floppy disks, and magnetic tapes, optical recording media such as compact disc read-only memories (CD-ROMs) and digital versatile discs (DVDs), magneto-optical recording media such as floptical disks, and hardware devices such as ROMs, RAMs, and flash memories that are especially configured to store and execute program commands. Examples of the program commands include machine language codes that may be generated by a compiler, and high-level language codes that may be executed by a computer by using an interpreter. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses and devices can include circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of displaying content, the method comprising:
displaying first content in a first view mode on a screen of a display device;
detecting a change from the first view mode to a second view mode; and
providing recommended content in the second view mode based on a result of analyzing the first content in response to the change to the second view mode being detected.

2. The method of claim 1, wherein the providing the recommended content comprises:
generating a keyword corresponding to the first content; and
updating the keyword in a database.

3. The method of claim 2, wherein the providing the recommended content comprises:
mapping the first content to the second content based on information stored in the database; and
determining the recommended content based on a result of mapping the first content to the second content.

4. The method of claim 3, wherein the mapping the first content to the second content comprises mapping the first content to the second content based on similarity between the first content and the second content.

5. The method of claim 1, wherein the providing the recommended content comprises changing an attribute of the second view mode in which the recommended content is displayed.

6. The method of claim 1, wherein the providing the recommended content comprises automatically launching the recommended content and displaying the first content and the recommended content together on the screen.

7. The method of claim 1, wherein the providing the recommended content comprises changing a sorting sequence of the recommended content according to a user setting.

8. The method of claim 1, wherein the providing the recommended content comprises:
determining whether a type of the first content corresponds to one of a broadcast content type, an application program type, and a webpage type;
generating a keyword corresponding to the first content based on an electronic program guide of the first content in response to the type of the first content corresponding to the broadcast content type;
generating the keyword from a property or an attribute of the first content in response to the type of the first content corresponding to the application program type; and
generating the keyword from a meta element of the first content in response to the type of the first content corresponding to the application program type.

9. The method of claim 1, wherein the providing the recommended content comprises displaying the recommended content in a format of one of a list format, a grid format, a pop-up format, a notification format, and a custom format.

10. The method of claim 1, wherein each of the first view mode and the second view mode comprises one of a single view mode, a multi view mode, a single user mode, and a multi user mode.

11. A display device comprising:
a display configured to display first content in a first view mode;
a detector configured to detect a change of a view mode; and
a controller configured to analyze the first content and provide recommended content in a second view mode based on a result of analyzing the first content.

12. The display device of claim 11, wherein the controller is further configured to generate a keyword corresponding to the first content, and update the keyword in a database.

13. The display device of claim 12, wherein the controller is further configured to map the first content to the second content based on information stored in the database, and determine the recommended content based on a result of the mapping.

14. The display device of claim 13, wherein the controller is further configured to map the first content to the second content based on similarity between the first content and the second content.

15. The display device of claim 11, wherein the controller is further configured to change an attribute of the second view mode in which the recommended content is displayed according to a user input.

16. The display device of claim 11, wherein the controller is further configured to automatically launch the recommended content.

17. The display device of claim 11, wherein the controller is further configured to change a sorting sequence of the recommended content according to a user setting.

18. The display device of claim 11, wherein the controller is further configured to determine whether a type of the first content corresponds to one of a broadcast content type, an application program type, and a webpage type; generate a keyword corresponding to the first content based on an electronic program guide of the first content in response to the type of the first content corresponding to the broadcast content type; generate the keyword from a property or an attribute of the first content in response to the type of the first content corresponding to the application program type; and generate the keyword from a meta element of the first content in response to the type of the first content corresponding to the application program type.

19. The display device of claim 11, wherein each of the first view mode and the second view mode comprises one of a single view mode, a multi view mode, a single user mode, and a multi user mode.

20. A non-transitory computer readable storage medium storing a program that is executable by a computer to perform the method of claim 1.
